(19) United States
(12) Patent Application Publication
(10) Pub. No.: US 2023/0234000 A1
(43) Pub. Date: Jul. 27, 2023

(54) LIQUID INFUSED MEMBRANE AND USES THEREOF

(71) Applicants: UNIVERSITY OF MASSACHUSETTS, Boston, MA (US); The Board of Trustees of the University of Maine System, Orono, ME (US)

(72) Inventors: Jessica Deborah Schiffman, Amherst, MA (US); Caitlin Lake Howell, Veazie, ME (US); Rushabh Manish Shah, Sunderland, MA (US)

(21) Appl. No.: 18/100,138

(22) Filed: Jan. 23, 2023

Related U.S. Application Data
(60) Provisional application No. 63/303,571, filed on Jan. 27, 2022.

(51) Int. Cl. B01D 67/00; C08J 9/42; B01D 71/52; B01D 71/34; B01D 69/02; B01D 61/14; C02F 1/44; B01D 65/08

(52) U.S. Cl. CPC B01D 67/0088; C08J 9/42; B01D 71/52; B01D 71/34; B01D 69/02; B01D 61/145; C02F 1/444; B01D 65/08; C08J 2327/16; C08J 2471/02; B01D 2325/02834; C02F 2303/20

(57) ABSTRACT

A liquid infused membrane includes a porous fluorine-containing polymer membrane and a perfluoropolyether oil coating on at least a portion of the first surface and at least a portion of the pore wall. Advantageously, the liquid infused membrane does not exhibit gating. Methods for the manufacture thereof and uses of the liquid infused membrane are also disclosed.

### CROSS-REFERENCE TO RELATED APPLICATION

This application claims priority to U.S. Provisional Application No. 63/303,571, filed Jan. 27, 2022, the contents of which is hereby incorporated by reference in its entirety.

### STATEMENT REGARDING FEDERALLY SPONSORED RESEARCH & DEVELOPMENT

This invention was made with government support under award numbers 1930610 and 1930710 awarded by the National Science Foundation. The government has certain rights in the invention.

### BACKGROUND

Degrading water quality is a persistent problem, which is corroborated by the fact that globally, 2.2 billion people lack access to clean drinking water. The World Economic Forum has declared that the water crisis is a societal and environmental risk leading to the transmission of diseases, including diarrhea, cholera, typhoid, and hepatitis A. One in nine children under the age of five die every day due to diarrhea making diarrhea the second leading cause of childhood mortalities worldwide.

To fight this water paucity and degrading water quality, membrane-based water treatment processes, including ultrafiltration are used because membrane-based technologies can effectively remove the particulates and pathogens (e.g., viruses and bacteria) that cause waterborne diseases. See, e.g., Boschi-Pinto, C.; Bull. World Health Organ. 2008, 86 (9), 710-717. However, over time biofouling, i.e., the accumulation of particulates and pathogens on the membrane and inside their pores, contribute to more than 45% of all membrane fouling (see, e.g., Stoller, M.; Baiocco, D.; Cicci, A.; Bravi, M.; Chem. Eng. Trans. 2016, 49, 589-594), as well as causes an increase in energy consumption and a decreased rate of clean water production. See, e.g., Dobosz, K. M.; Kolewe, K. W.; Schiffman, J. D.; Front. Microbiol. 2015, 6, 196.

Accordingly, there remains a continuing need for improved membranes. Preferably, the membranes will be antifouling, have high water flux, and be stable.

### SUMMARY

A liquid infused membrane comprises a porous fluorine-containing polymer membrane having a first surface and a second surface and comprising a plurality of pores, each pore defined by a pore wall comprising the fluorine-containing polymer; and a perfluoropolyether oil coating on at least a portion of the first surface and at least a portion of the pore wall, wherein a fluid can pass through the membrane when a transmembrane pressure is applied, and wherein the liquid infused membrane does not exhibit gating upon removal of the transmembrane pressure.

A method of the manufacture of the liquid infused membrane comprises contacting the perfluoropolyether oil with the porous fluorine-containing polymer membrane; and leaving or removing excess perfluoropolyether oil to provide the liquid infused membrane.

A method of water purification comprises passing water through the liquid infused membrane.

A water purification system comprises the liquid infused membrane.

A method of oil purification comprises passing an oil through the liquid infused membrane.

An oil purification system comprises the liquid infused membrane.

The above described and other features are exemplified by the following figures and detailed description.

### BRIEF DESCRIPTION OF THE DRAWINGS

The following figures represent exemplary aspects.

FIG. 1 shows VP-SEM micrographs acquired using (A-C) Secondary Electron and (D-F) BackScatter images of (A and D) bare, (B and E) K103-LIMs, (C and F) K107-LIMs. The inset digital images are the crystal violet stained bare, as well as K103- and K107-LIMs.

FIG. 2 shows normalized permeance for K103-LIMs and K107-LIMs as a function of transmembrane pressure (TMP). The dotted line represents the normalized permeance of the bare PVDF membrane. Error bars denote standard deviation, one asterisk (*) denotes a p≤0.05 significance between samples, and n.s. denotes samples were not statistically different.

FIG. 3 shows pure water permeance of K103-LIMs with a bare membrane pore size of 0.1 μm as a function of transmembrane pressure (TMP). Error bars denote standard deviation and n.s. denotes a non-statistically significant difference between samples.

FIG. 4 shows pure water permeance of K103-LIMs with a bare membrane pore size of 0.2 μm as a function of transmembrane pressure (TMP). Error bars denote standard deviation and n.s. denotes a non-statistically significant difference between samples.

FIG. 5 shows pure water permeance of K103-LIMs with a bare membrane pore size of 0.22 μm as a function of transmembrane pressure (TMP). Error bars denote standard deviation and n.s. denotes a non-statistically significant difference between samples.

FIG. 6 shows pure water permeance of K103-LIMs with a bare membrane pore size of 0.45 μm as a function of transmembrane pressure (TMP). Error bars denote standard deviation and one asterisk (*) denotes a p≤0.05 significance between samples.

FIG. 7 shows (A) pure water permeance of K107-LIMs with 15 or 30 minutes of resting time between testing cycles. (B) Pure water permeance of K103-LIMs and K107-LIMs with a 15 minute resting time between testing cycles. A TMP of 1.5 bar was used. Error bars denote standard deviation, and n.s. denotes that samples were not statistically different. The initial pure water permeance of compacted bare membranes is provided as a comparison and is statistically different from the LIMs.

FIG. 8 shows pure water permeance of K103-LIMs and K107-LIMs for 10 consecutive cycles. A TMP of 1.5 bar was used. Error bars denote standard deviation, one asterisk (*) denotes a p≤0.05 significance between samples, and n.s. denotes that samples were not statistically different. The initial pure water permeance of compacted bare membranes is provided as a comparison and is statistically different from the LIMs.

FIG. 9 shows pure water permeance of K103-LIMs with a bare membrane pore size of 0.1 μm for 5 consecutive cycles. A TMP of 0.5 bar was used. Error bars denote standard deviation and n.s. denotes a non-statistically significant difference between samples. The initial pure water permeance of compacted bare membranes is provided as a comparison and is statistically different from the LIMs.

FIG. 10 shows pure water permeance of K103-LIMs with a bare membrane pore size of 0.22 μm for 5 consecutive cycles. A TMP of 0.5 bar was used. Error bars denote standard deviation and n.s. denotes a non-statistically significant difference between samples. The initial pure water permeance of compacted bare membranes is provided as a comparison and is statistically different from the LIMs.

FIG. 11 shows Krytox/B are membrane (K/M ratio) for as-prepared and used K103-LIMs and K107-LIMs after pure water permeance testing at 1.5 bar TMP. The K/M ratio was calculated as described in the examples. Error bars denote standard error, one asterisk (*) denotes a p≤0.05 significance between samples, and n.s. denotes that samples were not statistically different.

FIG. 12 shows pure oil permeance of bare, K103-LIMs, and K107-LIMs with a bare membrane pore size of 0.45 μm for 30 min at a TMP of 0.5 bar. Error bars denote standard deviation and one asterisk (*) denotes a p≤0.05 significance between samples. The initial pure water permeance of compacted bare membranes is provided as a comparison.

FIG. 13 shows normalized water permeance and normalized oil permeance of K107-LIMs with a bare membrane pore size of 0.45 μm for 5 consecutive cycles. A TMP of 0.5 bar was used. Error bars denote standard deviation and one asterisk (*) denotes a p≤0.05 significance between samples.

FIG. 14 shows area coverage of E. coli after 2 hour incubation on bare, as well as as-prepared and used K103-LIMs and K107-LIMs after pure water permeance testing at 1.5 bar TMP. Error bars denote standard error, one asterisk (*) denotes a p≤0.01 significance between samples, and n.s. denotes that samples were not statistically different.

FIG. 15 shows flux decline and recovery of bare, K103-LIMs, and K107-LIMs with a bare membrane pore size of 0.45 μm during E. coli filtration and after membrane cleaning.

FIG. 16 shows flux recovery ratio (FRR) of bare, K103-LIMs, and K107-LIMs. Error bars denote standard deviation and one asterisk (*) denotes a p≤0.05 significance between samples.

### DETAILED DESCRIPTION

Various strategies to reduce biofouling during membrane operation have previously been explored, including both operational changes and altering membrane design. For example, researchers have investigated how both physical methods (i.e., flow-induced shear (see, e.g., Belfort, G. J. Membr. Sci. 1989, 40 (2), 123-147; Du, X.; Wang, Y.; Leslie, G.; Li, G.; Liang, H. J. Chem. Technol. Biotechnol. 2017, 92 (3), 463-478), gas sparging (see, e.g., Cui, Z. F.; Wright, K. I. T. J. Membr. Sci. 1996, 117 (1), 109-116; Laorko, A.; Li, Z.; Tongchitpakdee, S.; Youravong, W. Sep. Purif. Technol. 2011, 80 (3), 445-451)) and chemical methods (i.e., feed stream pretreatment (see, e.g., Liang, H.; Gong, W.; Li, G. Desalination 2008, 221 (1), 345-35014)) can decrease biofouling during membrane operation. However, these approaches have their own shortcomings. For example, flow-induced shear causes the breakage of foulant particles that lead to pore blocking. See, e.g., Du, X.; Wang, Y.; Leslie, G.; Li, G.; Liang, H. J. Chem. Technol. Biotechnol. 2017, 92 (3), 463-478. In terms of re-engineering the design of membranes via the inclusion of functional chemistries, a popular approach has been to blend active agents, such as biocides (see, e.g., Samantaray, P. K.; Kumar, S.; Bose, S. J. Water Process Eng. 2020, 38, 101536; Baker, J. S.; Dudley, L. Y. Desalination 1998, 118 (1), 81-89; Mansouri, J.; Harrisson, S.; Chen, V. J. Mater. Chem. 2010, 20 (22), 4567-4586) and/or antifouling biopolymers (see, e.g., Mateur, M. N.; Gonzalez Ortiz, D.; Jellouli Ennigrou, D.; Horchani-Naifer, K.; Bechelany, M.; Miele, P.; Pochat-Bohatier, C. Membranes 2020, 10 (7), 144; Zhou, W.; Fang, Y.; Li, P.; Yan, L.; Fan, X.; Wang, Z.; Zhang, W.; Liu, H. ACS Sustain. Chem. Eng. 2019, 7 (18), 15463-15470; Van Houdt, R.; Michiels, C. W. J. Appl. Microbiol. 2010, 109 (4), 1117-1131; Cappitelli, F.; Polo, A.; Villa, F. Food Eng. Rev. 2014, 6 (1), 29-42) into the body of the polymer membrane. This approach is often accompanied by a trade-off in membrane performance See, e.g., Fang, L.-F.; Zhu, B.-K.; Zhu, L.-P.; Matsuyama, H.; Zhao, S. J. Membr. Sci. 2017, 524, 235-244; Xu, J.; Feng, X.; Hou, J.; Wang, X.; Shan, B.; Yu, L.; Gao, C. J. Membr. Sci. 2013, 446, 171-180). Another drawback is that the bioactive moieties are located throughout the membrane versus the interfacial locations that are actively involved with separations and thus, higher loadings are required for activity. See, e.g., Taurozzi, J. S.; Arul, H.; Bosak, V. Z.; Burban, A. F.; Voice, T. C.; Bruening, M. L.; Tarabara, V. V. J. Membr. Sci. 2008, 325 (1), 58-68. While modifying membrane surfaces with antimicrobials (e.g., metal ions, titanium dioxide (see, e.g., Bodner, E. J.; Kandiyote, N. S.; Lutskiy, M.-Y.; Albada, H. B.; Metzler-Nolte, N.; Uhl, W.; Kasher, R.; Arnusch, C. J. RSC Adv. 2016, 6 (94), 91815-91823; Akar, N.; Asar, B.; Dizge, N.; Koyuncu, I. J. Membr. Sci. 2013, 437, 216-226; Tiraferri, A.; Yip, N. Y.; Phillip, W. A.; Schiffman, J. D.; Elimelech, M. J. Membr. Sci. 2011, 367 (1-2), 340-352)) and/or antifouling polymers (i.e., zwitterions, poly(ethylene glycol) (see, e.g., Yang, X.; Du, Y.; Zhang, X.; He, A.; Xu, Z.-K. Langmuir 2017, 33 (9), 2318-2324; Leng, C.; Sun, S.; Zhang, K.; Jiang, S.; Chen, Z. Acta Biomater. 2016, 40, 6-15; He, M.; Gao, K.; Zhou, L.; Jiao, Z.; Wu, M.; Cao, J.; You, X.; Cai, Z.; Su, Y.; Jiang, Z. Acta Biomater. 2016, 40, 142-15228-30)) can effectively concentrate active agents at the surface of the membrane, complicated chemistries, including chemical grafting, plasma treatment, and/or UV treatments are typically required. This impedes industrial scale up and prevents fouling only on the membrane's surface rather than within membrane's pores. See, e.g., Nayak, K.; Kumar, A.; Das, P.; Tripathi, B. P. J. Membr. Sci. 2021, 630, 119306; Ansari, A.; Peña-Bahamonde, J.; Wang, M.; Shaffer, D. L.; Hu, Y.; Rodrigues, D. F. J. Membr. Sci. 2021, 630, 119308; Oshiba, Y.; Harada, Y.; Yamaguchi, T. J. Membr. Sci. 2021, 619, 118772; Miller, D. J.; Dreyer, D. R.; Bielawski, C. W.; Paul, D. R.; Freeman, B. D. Angew. Chem. Int. Ed. 2017, 56 (17), 4662-4711; Venault, A.; Wei, T.-C.; Shih, H.-L.; Yeh, C.-C.; Chinnathambi, A.; Alharbi, S. A.; Carretier, S.; Aimar, P.; Lai, J.-Y.; Chang, Y. J. Membr. Sci. 2016, 516, 13-25. Thus, an alternative, straightforward approach that transforms all active sites of membranes (surface and pores) to be fouling resistant without compromising consistent separation performance is needed.

In nature, the Nepenthes pitcher plant uses a thin, immobilized liquid layer to create an ultra-slippery surface which causes insects to slide down into its cup. See, e.g., Bohn, H. F.; Federle, W. Proc. Natl. Acad. Sci. U.S.A 2004, 101 (39), 14138-14143. To mimic this behavior, liquid layers have been immobilized on the surface of highly wettable microstructures, creating a pressure-stable, omniphobic antifouling coating on solid surfaces, commonly known as slippery liquid-infused porous surfaces (SLIPS). See, e.g., Wong, T.-S.; Kang, S. H.; Tang, S. K. Y.; Smythe, E. J.; Hatton, B. D.; Grinthal, A.; Aizenberg, J. Nature 2011, 477 (7365), 443-447. SLIPS have been reported to repel a wide range of contaminants, including crude oil, proteins, blood, and bacteria. See, e.g., Leslie, D. C.; Waterhouse, A.; Berthet, J. B.; Valentin, T. M.; Watters, A. L.; Jain, A.; Kim, P.; Hatton, B. D.; Nedder, A.; Donovan, K.; Super, E. H.; Howell, C.; Johnson, C. P.; Vu, T. L.; Bolgen, D. E.; Rifai, S.; Hansen, A. R.; Aizenberg, M.; Super, M.; Aizenberg, J.; Ingber, D. E. Nat. Biotechnol. 2014, 32 (11), 1134-1140; Sunny, S.; Vogel, N.; Howell, C.; Vu, T. L.; Aizenberg, J. Adv. Funct. Mater. 2014, 24 (42), 6658-6667; Sunny, S.; Cheng, G.; Daniel, D.; Lo, P.; Ochoa, S.; Howell, C.; Vogel, N.; Majid, A.; Aizenberg, J. Proc. Natl. Acad. Sci. 2016, 113 (42), 11676-11681; Epstein, A. K.; Wong, T.-S.; Belisle, R. A.; Boggs, E. M.; Aizenberg, J. Proc. Natl. Acad. Sci. 2012, 109 (33), 13182-13187; MacCallum, N.; Howell, C.; Kim, P.; Sun, D.; Friedlander, R.; Ranisau, J.; Ahanotu, O.; Lin, J. J.; Vena, A.; Hatton, B.; Wong, T.-S.; Aizenberg, J. ACS Biomater. Sci. Eng. 2015, 1 (1), 43-51. Inspired by this work, Hou et al. (Nature 2015, 519 (7541), 70-73) demonstrated that a lubricating oil could be infused into polytetrafluoroethylene (PTFE) filters with 0.2 μm, 5.0 μm, and 20.0 μm pore sizes. At ambient pressure (0 bar), the liquid filled the large, 5.0 μm pores, whereas when a threshold transmembrane pressure (0.33 bar) was applied, the liquid was stabilized by capillary forces within the pores creating a non-fouling, liquid-lined pore. See, e.g., Overton, J. C.; Weigang, A.; Howell, C. J. Membr. Sci. 2017, 539, 257-262. The threshold pressure required to open the pores depended on the size, geometry, composition of the bare membrane and the surface tension of the lubricating liquid. See, e.g., Bazyar, H.; Lv, P.; Wood, J. A.; Porada, S.; Lohse, D.; Lammertink, R. G. H. Soft Matter 2018, 14 (10), 1780-1788. To date there have been no reports that SLIPS or a liquid oil layer could be used in conjunction with commercial membranes for use in liquid separations at industrially relevant transmembrane pressures and over multiple cycles.

Here, the present inventors have discovered liquid-infused membranes that provide consistent pure water and/or oil flux at industrially relevant transmembrane pressures. Using omniphobic perfluoropolyether liquids with varying viscosities, the present inventors have confirmed the formation of a stable liquid layer on polyvinylidene fluoride membranes. The pure water permeance of these liquid-infused membranes was tested with varying pressure, resting time, and over ten testing cycles using a dead-end filtration unit. The highly antifouling properties of these composite membranes were also demonstrated.

Accordingly, an aspect of the present disclosure is a liquid infused membrane. The liquid infused membrane comprises a porous fluorine-containing polymer membrane (also referred to herein as “the membrane” for simplicity). The membrane has a first surface and a second surface (which may also be referred to as a top surface and a bottom surface), and further comprises a plurality of pores. The pores can be interconnected within the membrane. In an aspect, one or more pores can extend through the thickness of the membrane (i.e., from the first surface to the second surface). In an aspect, one or more pores can be discontinuous. For example, the pores can be discontinuous and interconnected to provide an indirect path through the membrane (e.g., sponge-like). In an aspect, the membrane can comprise a combination of discontinuous pores and pores extending through the thickness of the membrane. In an aspect, the pores of the membrane form at least one continuous path through the thickness of the membrane. The pores are defined by a pore wall, which comprises a fluorine-containing polymer (i.e., the same fluorine-containing polymer that makes up the fluorine-containing polymer membrane).

The porous fluorine-containing polymer membrane can generally comprise any polymer comprising repeating units having at least one fluorine group. Polymer blends wherein at least one of the polymers present in the blend comprises repeating units having at least one fluorine group are mentioned. In an aspect, the porous fluorine-containing polymer membrane can comprise a non-fluorinated polymer having a fluorinated coating disposed thereon, wherein the fluorinate coating can comprise a fluorine-containing polymer. Exemplary fluorine-containing polymers for the membrane (or, when present, a fluorinate coating) include polyvinylidene fluoride (PVDF), polytetrafluoroethylene (PTFE), polyvinyl fluoride (PVF), polychlorotrifluoroethylene (PCTFE), perfluoroalkoxy polymer (PFA), fluorinated ethylene-propylene (FEP), polyethylenetetrafluoroethylene (ETFE), polyethylenechlorotrifluoroethylene (ECTFE), a perfluorinated elastomer (e.g., comprising a vinylidene fluoride-based copolymer, a tetrafluoroethylene-propylene copolymer, and the like), perfluoropolyether (PFPE), fluorinated polymer zwitterions, and the like, or a combination thereof. In an aspect, the membrane comprises polyvinylidene fluoride, polytetrafluoroethylene (PTFE), or a combination thereof. In an aspect, the membrane comprises polyvinylidene fluoride.

The porous membrane can generally have any porosity. A range of pore sizes can be used. For example, the porous membrane can have an average pore diameter of 0.1 to 20 μm. In an aspect, the porous membrane can have an average pore diameter of less than 1 μm, for example 0.1 to less than 1 μm, or 0.1 to 0.95 μm, or 0.1 to 0.9 μm, or 0.1 to 0.6 μm, or 0.1 to 0.5 μm. In an aspect, the porous membrane can have an average pore diameter of 0.35 to 0.55 μm, or 0.4 to 0.5 μm. In an aspect, the porous membrane can have an average pore diameter of 0.1 to 0.25 μm. It will be understood that the aforementioned average pore diameters refer to the average pore diameter of the pores of the membrane prior to contact with the perfluoropolyether oil (e.g., the bare membrane). Following deposition of the perfluoropolyether oil, the average pore diameter may or may not be different from the average pore diameter of the uncoated porous membrane.

The liquid infused membrane comprises a perfluoropolyether oil on the membrane. For example, the perfluoropolyether oil can form a coating disposed on at least a portion of the first surface of the porous membrane. The perfluoropolyether oil is further disposed on at least a portion of a pore wall of the membrane. Stated another way, the perfluoropolyether oil forms a coating disposed on at least a portion of the pore wall within the membrane. The second surface of the membrane can optionally further comprise the perfluoropolyether oil. The perfluoropolyether oil is therefore stably infused on and within the membrane. The perfluoropolyether oil can be stabilized by capillary forces within the pores creating a perfluoropolyether oil-lined pore.

Preferably the viscosity of the perfluoropolyether oil is higher than a fluid to be passed through the liquid infused membrane. For example, the viscosity of the perfluoropolyether oil can be higher than the viscosity of water. For example, the viscosity of the perfluoropolyether oil can be higher than the viscosity of oil. Without wishing to be bound by theory, it is believed that the relative viscosities of the perfluoropolyether oil and the fluid to be passed through the membrane can contribute to the stability of the liquid infused membrane. Thus, movement or loss of the perfluoropolyether oil from the liquid infused membrane is negligible when a fluid is passed through the liquid infused membrane once a steady state has been reached. In an aspect, the perfluoropolyether oil can be immiscible with a fluid (e.g., water) to be passed through the liquid infused membrane.

The perfluoropolyether oil can have the structure F—(CF(CF₃)CF₂O)n-CF₂CF₃, wherein n is 10 to 60. Such perfluoropolyether oils are commercially available under the tradename KRYTOX from DuPont. In an aspect, the perfluoropolyether oil can have a viscosity of 75 to 90 cSt (0.000075 to 0.00009 m² s⁻¹) at a temperature of 20° C., preferably 75 to 85 cSt (0.000075 to 0.000085 m² s⁻¹). In an aspect, the perfluoropolyether oil can have a viscosity of 1500 to 1550 cSt (0.0015 to 0.00155 m² s⁻¹) at a temperature of 20° C., preferably 1525 to 1545 cSt (0.001525 to 0.001545 m² s⁻¹).

The amount of the perfluoropolyether oil immobilized on the membrane can vary, and in some aspects can be dictated by factors including the viscosity of the perfluoropolyether oil and the pore size of the membrane. In an aspect, the perfluoropolyether oil can be present in the liquid infused membrane in a perfluoropolyether oil:membrane weight ratio of 0.2:1 to 1.5:1, or 0.3:1 to 0.5:1, or 0.75:1 to 0.9:1. It is noted that the recited weight ratios can be after removal of excess perfluoropolyether oil. As discussed in further detail below, excess perfluoropolyether oil can be removed by, for example, allowing any excess to run off the surface of the membrane (e.g., by gravity). Excess perfluoropolyether oil can also be removed by application of light pressure (e.g., 0.5 bar) to compact the liquid infused membrane. It is therefore understood that the perfluoropolyether oil can be present in the liquid infused membrane in a perfluoropolyether oil:membrane weight ratio that exceeds the aforementioned weight ratios.

In a specific aspect, the liquid infused membrane can comprise a porous polyvinylidene fluoride membrane, and a perfluoropolyether oil having the structure F—(CF(CF₃)CF₂O)n-CF₂CF₃, wherein n is 10 to 60 on the porous polyvinylidene fluoride membrane. For example, the perfluoropolyether oil can have a viscosity of 75 to 90 cSt (0.000075 to 0.00009 m² s⁻¹) at a temperature of 20° C. In an aspect, the perfluoropolyether oil can have a viscosity of 75 to 90 cSt (0.000075 to 0.00009 m² s⁻¹) at a temperature of 20° C. and be present in a perfluoropolyether oil:membrane weight ratio of 0.3:1 to 0.5:1. In another example, the

In an aspect, the perfluoropolyether oil can have a viscosity of 1500 to 1550 cSt (0.0015 to 0.00155 m² s⁻¹) at a temperature of 20° C. In an aspect, the perfluoropolyether oil can have a viscosity of 1500 to 1550 cSt (0.0015 to 0.00155 m² s⁻¹) at a temperature of 20° C. and can be present in a perfluoropolyether oil:membrane weight ratio of 0.75:1 to 0.9:1.

In some aspects, when the perfluoropolyether oil is applied to the membrane, the perfluoropolyether oil may fill the entirety of the pore. Accordingly, the liquid infused membrane can exhibit an initial threshold pressure. Below the initial threshold pressure, no fluid can pass through the pores. Above the initial threshold pressure as fluid is introduced to the liquid infused membrane, at least a portion of the perfluoropolyether oil can be displaced (e.g., pushed further into the membrane, or formed into a coating on the pore wall) to allow the fluid to pass through the membrane. For example, the liquid infused membrane can exhibit an initial threshold pressure of 0.5 to 2 bar, or 0.5 to 1.5 bar, or 0.5 to 1 bar. In some aspects, the liquid infused membrane does not exhibit an initial threshold pressure in order to a fluid to pass through the liquid infused membrane.

In an advantageous feature, the liquid infused membranes of the present disclosure do not exhibit gating. The term “gating” as used herein refers to refilling of the pores with the oil to effectively seal the pore when flow of a fluid through the membrane is stopped (i.e., the pressure is decreased). In a gating system, a minimum (threshold) pressure will be required each time flow is started through the membrane in order to open the pores and allow transport of the fluid. The liquid infused membranes disclosed herein do not exhibit gating when the system pressure is decreased. Accordingly there is no need to incorporate a resting time to facilitate flux recovery as is required in many presently known systems. This can advantageously allow for continuous use of the liquid infused membrane described herein.

In a further advantageous feature, the perfluoropolyether oil is stably adhered to the porous membrane, and no loss of the oil was observed even over many cycles.

Additionally, the presence of the perfluoropolyether coating provides a stable antifouling surface. For example, the liquid infused membrane can reduce adhesion of bacteria by at least 45%, or by at least 50% relative to a porous fluorine-containing polymer membrane not including the perfluoropolyether oil.

A fluid can be passed through the liquid infused membranes. In an aspect the membrane can be positioned such that the fluid can traverse the thickness of the membrane (i.e., from the first surface to the second surface). In an aspect, the fluid to be passed through the membrane can have a lower viscosity than the perfluoropolyether oil and/or can be immiscible with the perfluoropolyether oil. In an aspect, the membrane and the perfluoropolyether oil can be selected such that wetting of the membrane with the perfluoropolyether oil is preferred over wetting of the membrane with the fluid. In an aspect, the fluid is an aqueous fluid comprising water. In another aspect, the fluid can be an oil.

The fluid can pass through the membrane when a transmembrane pressure is applied. As used herein, “transmembrane pressure” refers to a pressure effective to transport the fluid through the membrane. In some aspects, the transmembrane pressure can be greater than or equal to 1 bar. In an aspect, the transmembrane pressure can be less than or equal to 10 bar. Within these ranges, the transmembrane pressure can be 1 to 5 bar, or 1.5 to 5 bar, or 1.5 to 4 bar. In an aspect, the force of gravity may be sufficient to provide a transmembrane pressure effective to transport the fluid through the membrane. Advantageously, the liquid infused membrane does not exhibit gating upon removal of the transmembrane pressure. Stated another way, the pores of the membrane do not refill with the perfluoropolyether oil upon removal of the transmembrane pressure.

In an aspect, the liquid infused membrane exhibits pure water permeance at a transmembrane pressure of greater than or equal to 1 bar, preferably 1 to 5 bar, or 1.5 to 5 bar, or 1.5 to 4 bar. In an aspect, the pure water permeance is less than the pure water permeance of the porous fluorine-containing polymer membrane not including the perfluoropolyether oil.

In an aspect, the liquid infused membrane can exhibit pure oil permeance at a transmembrane pressure of less than or equal to 5 bar, or less than or equal to 2 bar, or 0.1 to 5 bar, or 0.1 to 2 bar, or 0.1 to 0.75 bar, or 0.25 to 0.75 bar, or 1 to 2 bar, or 1.25 to 1.75 bar.

In an aspect, the liquid infused membrane can exhibit both the aforementioned pure water permeance and pure oil permeance.

For example, for a liquid infused membrane having a pore size of 0.45 μm, the liquid infused membrane can exhibit a pure water flux that is 60% or less of the pure water flux of the porous fluorine-containing polymer membrane not including the perfluoropolyether oil at a transmembrane pressure of 1 to 4 bar. In an aspect, for a liquid infused membrane having a pore size of 0.45 μm, the liquid infused membrane can exhibit a pure water permeance that is 60% or less of the pure water permeance of the porous fluorine-containing polymer membrane not including the perfluoropolyether oil at a transmembrane pressure of 3 to 4 bar. In an aspect, for a liquid infused membrane having a pore size of 0.45 μm, the liquid infused membrane can exhibit a pure water permeance that is 40% or less of the pure water permeance of the porous fluorine-containing polymer membrane not including the perfluoropolyether oil at a transmembrane pressure of 2 bar.

In an aspect, a liquid infused membrane having an average pore size of 0.45 μm can exhibit a pure water permeance of 2500 to 3500 Lm⁻² h⁻¹ bar⁻¹ at a transmembrane pressure of 1.5 bar.

In an aspect, the pure water permeance of the liquid infused membrane changes by less than 35% over the course of 10 cycles. In an aspect, the 10 cycles can be conducted at a pressure of 1.5 bar, and each cycle can take, for example, 15 to 60 minutes, or 20 to 40 minutes, or 30 minutes. It will be understood that the time and volume of water that passes through the liquid infused membrane can be affected based on, for example, the pressure used for conducting the experiment. In an aspect, a resting time can be incorporated between each cycle. “Resting time” as used herein refers to a period of time with no flow through the membrane. The resting time can be, for example, 1 to 30 minutes, or 15 to 30 minutes. In an aspect, the incorporation of a resting time between cycles does not added the pure water permeance of the liquid infused membrane. The lack of change in permeance of the liquid infused membranes is indicative of the stability of the perfluoropolyether oil on the porous membrane, and further that the pores are not gated.

A method for the manufacture of a liquid infused membrane represents another aspect of the present disclosure. The method comprises contacting the perfluoropolyether oil with the porous fluorine-containing polymer membrane. Contacting the perfluoropolyether oil with the membrane can be various coating techniques which are generally known, for example, spin coating, dip coating, solvent casting, spray coating, drop casting, screen printing, soaking, and the like or a combination thereof. The method further comprises removing excess perfluoropolyether oil to provide the liquid infused membrane. Removing excess oil can be by, for example, allowing any excess to run or drip off the membrane (e.g., by gravity), or by application of light pressure to drive out excess perfluoropolyether oil.

In an aspect, the steps of contacting with the perfluoropolyether oil and removing excess perfluoropolyether oil can be repeated in order to achieve a desired perfluoropolyether oil/membrane weight ratio.

The liquid infused membrane of the present disclosure having the technical advantages described herein can be used in various applications, for example where liquid separation is desired. For example, the liquid infused membranes can be useful for water purification application, where water can be passed through the liquid infused membrane.

This disclosure is further illustrated by the following examples, which are non-limiting.

### EXAMPLES

### Materials and Methods

The following materials were used in the examples. Perfluoropolyether (PFPE) Krytox™ 103 (K103), a low viscosity lubricant (82 cSt) and perfluoropolyether Krytox™ 107 (K107), a higher viscosity lubricant (1535 cSt) were obtained from Chemours, Wilmington, Del. Polydimethylsiloxane silicone oil (1 cSt) was purchased form Clearco Products (Willow Grove, Pa.). Isopropyl alcohol (IPA, 70% v/v) was purchased from Thermo Fisher Scientific (Waltham, Mass.). ACS reagent grade acetone was purchased from Fisher Scientific (Hampton, N.H.). Deionized (DI) water was obtained from a Barnstead Nanopure Infinity water purification system (resistance of 18.2 MΩ cm, Thermo Fisher Scientific). Sodium hypochlorite (NaClO) was purchased from The Clorox Company (Oakland, Calif.). Luria-Bertani broth (LB), M9 minimal salts (M9 media), sodium chloride (NaCl), D-(+)-glucose, carbenicillin (BioReagent grade) and crystal violet (ACS reagent, >90%, anhydrous basis) were purchased from Sigma-Aldrich (St. Louis, Mo.).

### Fabrication of Liquid Infused Membranes (LIMs)

Commercial polyvinylidene difluoride (PVDF) membranes with reported pore sizes of 0.1, 0.2, 0.22, and 0.45 μm were purchased from Thermo Fisher Scientific (0.2 and 0.45) and EMD Millipore (0.1 and 0.22) and used in all studies. Prior to use, a flushing procedure was conducted to remove glycerol from the membrane's pores. Membranes were submerged in a 70% IPA for 0.5 hours before being rinsed with DI water three times. All flushed membranes were stored in DI water at 4° C. until use.

To prepare the liquid-infused membranes (LIMs), 6 μL cm⁻² of K103 or 15 μL cm⁻² of K107 was applied to the surface of a flushed and compacted membrane using a micropipette. The liquid was allowed to spread across the membrane surface and into the pores for 30 minutes. Membranes were then suspended vertically for 60 minutes to remove excess lubricant using gravitational forces. The previously mentioned quantities of PFPE were systematically optimized, as discussed below. The composite ultrafiltration membranes coated with Krytox 103 or Krytox 107 are referred to as K103-LIM and K017-LIM, respectively. The control PVDF membranes without a lubricating liquid layer are referred to as the bare membrane.

### Characterization of LIMs

Variable pressure scanning electron microscopy (VP-SEM, ThermoFisher VolumeScope V2), with an acceleration voltage of 5 kV and variable pressure of 0.38 torr was used to characterize the surface morphology of both the bare membranes and LIMs. Images were captured in Secondary Electrons (SE, 15 pA) and BackScatter (BS, 400 pA) imaging modes. To qualitatively confirm the presence of the lubricant layer, crystal violet was applied to wet LIMs because as an aqueous stain, it can only stain portions of the membranes that lack the lubricant. LIMs and bare membranes were submerged in 1.5 mL of 0.001% aqueous crystal violet stain that was agitated at 90 rpm using a MaxQ2000 (Thermo Fisher Scientific) for 20 minutes. Digital images of the membranes were captured using a OnePlus 6t 16+20 Mega Pixel camera. Static contact angle measurements were acquired using 10 μL drops of DI water on the bare membranes using a Canon EOS 6D Mark II camera with a 100-mm macro lens (Canon, Huntington, N.Y.). Tilt contact angle measurements were performed by placing a 25 μL DI water droplet on one side of the bare membrane or LIM, which was placed on a AP180-Adjustable Angle Mounting Plate (Thorlabs, Newton, N.J.) equipped with an AccuMaster digital level/angle gauge (Carson, Nev.). The stage was slowly tilted until the water droplet started to move. Between each tilt angle measurement, the membrane was rotated by 45° to ensure that no water droplet moved along the same path twice. If no droplet movement occurred before 45°, the measurement was declared a failure. The reported static contact angles and tilt angles are the averages of 12 drops acquired over 4 different samples.

### Performance of LIMs

Pure water permeance experiments were conducted using a 10 mL dead-end stirred cell (Sterlitech, Kent, Mass.). The membrane active area was 3.8 cm². The dead-end stirred cell was pressurized using a nitrogen (N₂) tank and the flux was calculated by measuring the change of mass on the permeate side using a digital weighing scale (U.S. Solid, Cleveland, Ohio). First, each flushed bare membrane was compacted for 0.5 hours at 3 bar pressure, which ensured that the flux change was less than 5%. Next, permeance tests on the LIMs were performed for 0.5 hours at four different transmembrane pressures (TMPs=1, 2, 3, and 4 bar). Flux as a function of the volume of water that permeated through the membrane (ΔV), membrane area (A) and time (Δt) was calculated using Equation 1, whereas pure water permeance and normalized permeance were determined using Equations 2 and 3, respectively.

$$Flux ( \frac{L}{{m}^{2} - h} ) = \frac{Δ V}{A Δ t} \qquad ( Equation 1 )$$

$$Permeance ( \frac{L}{{m}^{2} - h - bar} ) = \frac{Flux}{TM P} \qquad ( Equation 2 )$$

$$Normalized permeance ( \frac{P W P}{P W {P}_{o}} ) = \frac{Pure water permeance of LIMs}{Pure water permeance of bare membrane} \qquad ( Equation 3 )$$

The effect of resting time on the long-term pure water permeance of the LIMs was explored. Five filtration cycles, which were each 30 min in duration were performed on the same LIM at 1.5 bar TMP. After each cycle of pure water flow, the LIMs were allowed to rest for 15 or 30 min, i.e., they remained undisturbed in the dead-end stirred cell with no pressure gradient, washing, or other contact. The LIM remained in the dead-end cell for all 5 testing cycles and no additional Krytox was added to the system. The same water was used for all 5 cycles of a resting time experiment.

Continuous long-term permeance experiments were also conducted on the LIMs. Ten filtration cycles (30 min each) were performed on the same LIM sample at 1.5 bar TMP. There was no resting time (0 min) between the continuous testing cycles. The membrane sample being tested remained in the dead-end stirred cell for the entire duration of the ten cycles of testing. No additional Krytox was added to the system. The same water was used for all 10 cycles of the long-term experiment.

Pure oil permeance experiments were performed on 0.45 μm pore size bare, K103-LIMs, and K107-LIMs by applying a TMP of 0.5 bar 30 min each. Flux, permeance, and normalized permeance were determined using Equation 1, Equation 2, and Equation 3, respectively. Continuous long-term oil permeance experiments were performed using 0.45 μm pore size bare and K107-LIMs for five cycles (30 min each) at 0.5 TMP.

Thermogravimetric analysis (TGA, Q50, TA instruments) was conducted to determine the percentage of PFPE that remained on the as-prepared and used LIMs (post-permeance experiments). A membrane sample (6-12 mg) loaded onto a platinum pan was heated from 25° C. to 700° C. at a temperature ramp of 10° C. min⁻¹. The nitrogen was purged at a flow rate of 40 mL min⁻¹ for the balance and 60 mL min⁻¹ for the sample. The ratio of PFPE to membrane was determined by using the TGA and Equation 4:

$$K / M Ratio = \frac{Krytox ( \% )}{Bare Membrane ( \% )} \qquad ( Equation 4 )$$

### Antifouling Activity of LIMs

Bacteria antifouling tests were conducted as reported in ACS Appl. Bio Mater. 2019, 2 (9), 3926-3933 using Escherichia coli K12 MG1655 (E. coli), a Gram-negative strain purchased from DSMZ, Leibniz-Institut, Germany, containing a green fluorescent protein (GFP) plasmid. Control glass coverslips (22 mm×22 mm, Fisher Scientific, Hampton, N.H.) were cleaned by submerging them in an acetone bath (stirred at 60 rpm) for 10 minutes followed by rinsing with autoclaved DI water three times, before being dried at 60° C. for 16 hours and treated with UV/ozone (ProCleaner™, Bioforce Nanosciences, Ames, Iowa) for 10 minutes. Both sides of the bare membranes (circular coupons with 2.54 cm diameters) were sterilized using a UV lamp (UVP UVGL-58, Analytik Jena US, Upland, Calif.) for 10 minutes. K103 and K107 oils were sterilized by passing them through a sterile vacuum filter of 0.45 μm pore size (Stericup™ Quick Release, EMD Millipore Corporation, Billerica, Mass.). Post sterilization, the bare membranes were coated with sterilized K103 or K107 to fabricate the LIMs, as described previously. E. coli was inoculated with 100 μg mL⁻¹ of carbenicillin and grown overnight in LB media at 37° C. to a concentration of 10⁸ cells mL⁻¹. All membrane samples were placed at the base of six-well plates (Fisher Scientific) to which 5 mL of M9 media containing 250 μL of E. coli was added to each of the six wells and placed in an incubator at 37° C. for 2 hours. Membrane samples were then removed from the six-well plates and gently rinsed with M9 to remove the loosely adherent bacteria. At least 15 random images of the samples with adhered microbes were acquired using two parallel replicates on three different days using an Axio Imager A2M microscope (20× magnification, Zeiss, Thornwood, N.Y.). Bacteria colony area coverage (%) was calculated using the particle analysis function in ImageJ 1.53a software.

### Dynamic Bacterial Fouling of Liquid-Infused Membranes

Dynamic fouling experiments were performed on the liquid-infused membranes with a model bacteria Escherichia coli K12 MG1655 (E. coli) according to the work of Dobosz et al (Langmuir 2019, 35 (5), 1872-1881). First, a UV lamp was used for 10 min to sterilize both sides of each membrane coupon. E. coli was inoculated with 100 μg mL⁻¹ carbenicillin and grown overnight in LB and resuspended in PBS (pH 7.4 to 7.6) to a concentration of 10⁷ cells mL⁻¹. The initial water flux, J_{w,i}, was measured by passing 1 L of DI water at 1.5 bar TMP and determined using Eq 1, where ΔV_{DIwater} is the volume of water that permeates through the membrane, A is the membrane area, and Δt is the time.

$${J}_{E . c o l i} ( \frac{L}{{m}^{2} h} ) = \frac{Δ {V}_{E . coli}}{A Δ t} \qquad ( 5 )$$

$$F R R ( \% ) = ( {J}_{( w , f )} ) / {J}_{w , i} \qquad ( 6 )$$

The biofouling experiment was carried out using 100 mL of bacteria suspensions at 1.5 bar TMP and a stir rate of 600 rpm to find the flux rate, J_{E. coli} (Eq 5) consistent with the work of Dobosz et al. Post E. coli filtration, the membrane coupons were rinsed for 10 min using DI water and pure water flux, J_{w,f} (Eq 2), was re-measured to calculate the flux recovery ratio (FRR). FRR is the ratio of final pure water flux and initial pure water flux of the membranes (Eq 6). Dynamic fouling experiments were performed in triplicate.

### Statistical Significance

For all the data, an unpaired student's t-test was used to determine the statistical significance difference between samples. Significance is denoted in the graphs using asterisks (*) and defined in figure captions. All the experiments were conducted in triplicate.

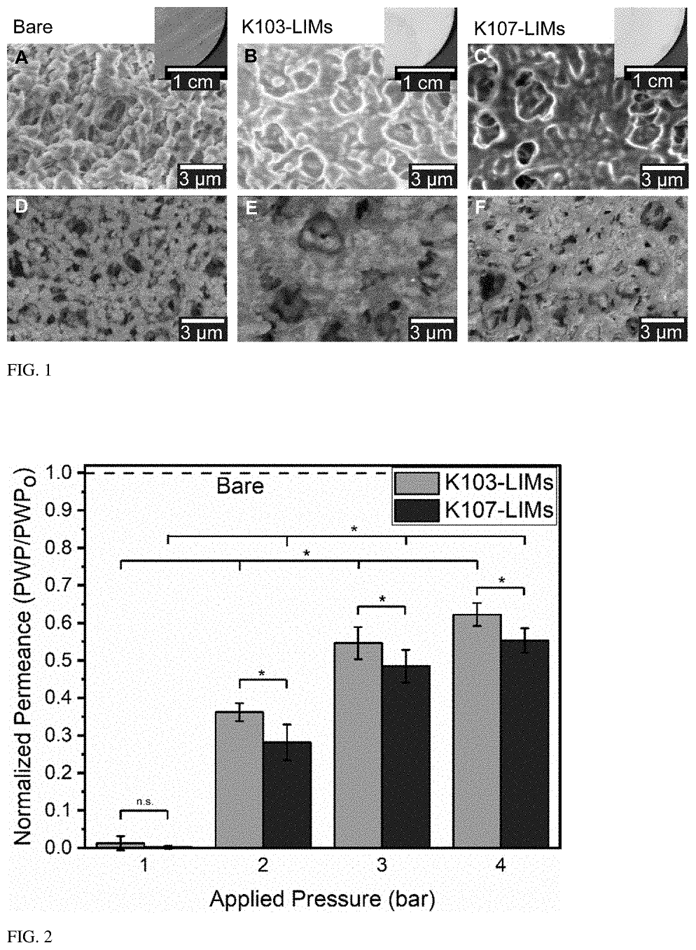

The present inventors sought to create a continuous and stable lubricant layer in the pores and on the surface of membranes to enhance the fouling resistance of high-performance membranes by liquid-infusion. Commercial polyvinylidene fluoride (PVDF) membranes were selected to serve as the base membranes because of their chemical affinity for the perfluoropolyether liquid that results from the presence of fluorine groups, their durability, and because they are commonly used in the separation industry. While a Magellan 400 XHR scanning electron microscope (FEI, Hillsboro, Oreg.) was able to capture images of the control bare membrane, images could not be acquired after the application of the oil. Thus, in FIG. 1, VP-SEM micrographs are presented for all membrane samples. The bare membranes display a polydispersed pore size distribution (FIG. 1A) and a fibrous-like structure with inter-connected pores was also observed.

Liquid-infused membranes (LIMs) were fabricated using the PVDF membranes as the base and Krytox 103 or 107 as the perfluoropolyether (PFPE) oil having a low (82 cSt) or high (1535 cSt) viscosity, as the infusion lubricant. The quantity of K103 or K107 that needed to be applied to the surface of the membranes was selected based on the previous literature (Soft Matter 2018, 14 (10), 1780-1788) and further optimized. Visually, sufficient lubricating oil was added so that it could be evenly spread over the entire surface of the membrane and the surface appeared shiny to the unaided eye. All membranes coated with the oil were held vertically for 60 minutes, which allowed any excess liquid to runoff the membrane. In the case of both oils, the quantity was lower (6 μL cm⁻² for K103 and 15 μL cm⁻² for K107) than that reported in literature (250 μL cm⁻²) potentially due to the different chemistry (PTFE versus PVDF) and/or the difference in pore size and/or geometry of the base materials. Because the K107 PFPE has a higher viscosity than K103, a greater quantity of K107 was required to spread evenly over the membranes. This is the first time that the oils have been applied to separation membranes.

Micrographs acquired on LIMs using Secondary Electron imaging show that the immobilized oils visually appeared to have generally decreased the pore diameters (see FIG. 1B, C). Due to the heterogeneous nature of the membrane, it was not possible to accurately measure an average pore diameter of either the bare membranes or the LIMs. To provide an idea of the range of pore sized observed, measurements acquired on active side of the bare and LIMs varied from 1-4 μm. When using BackScatter mode, the LIMs (FIG. 1E, F) had an enhanced bright field compositional contrast compared to the bare membranes (FIG. 1D) due to the presence of additional fluorine groups in the oil. This was also expected because the densities of the oils (K103=1.92 g cm⁻³ and K107=1.95 g cm⁻³) are greater than the PVDF membranes (1.78 g cm⁻³) thus, increasing the bright contrast of the LIMs versus the bare membranes. Because the BackScatter imaging mode uses a higher current, the electrons do penetrate into the membrane's body and down into the pores; this increased penetration depth results in the increased contrast and suggests the presence of oil inside the membrane pores.

To further confirm the presence of the lubricating oil coating the entire membrane surface, the LIMs were submerged into the aqueous crystal violet stain that would not be able to dye the perfluoropolyether lubricant oils. As shown in the inset image in FIG. 1A, the bare PVDF membrane was fully stained, whereas the K103- and K107-LIMs both stayed their original white color (FIG. 1B, 1C), thereby strongly suggesting the presence of the PFPE on the membrane's surface.

The hydrophobicity of the bare membranes was determined using static water contact angle measurements. The bare membranes had a hydrophobic contact angle of 115±8°. Static contact angles for LIMs are not provided because it has been reported to be an unreliable measurement; the oil layer can wrap around the water droplet giving a false contact angle measurement. Thus, tilt contact angle measurements were determined for the LIMs and bare membranes to examine the continuity and functionality of the liquid layer. Table 1 shows that no water droplet movement was observed on the bare membrane before a tilt angle of 45°, whereas immediately after applying the oil, the LIMs displayed a statistically lower tilt angle of 9°.

TABLE 1

| Membrane | Static Contact Angle (°) | Tilt Contact Angle (°) |
|---|---|---|
| Bare PVDF | 115 ± 8 | >45 |
| Membrane | Tilt Contact Angle | Tilt Contact Angle |
| | Post-Liquid | Post-60 min |
| | Infusion (°)^{†} | of vertical suspension (°)^{‡} |
| K103-LIM | 9 ± 4 | 37 ± 7* |
| K107-LIM | 9 ± 3 | 19 ± 8* |

^{†}Post-liquid infusion implies that there may be excess oil on the surface
^{‡}These fully prepared LIMs include the 60 min of vertical suspension post-liquid infusion; this is the full preparation method used throughout this study
*Denotes a p ≤ 0.05 significance between samples

The LIMs were held vertically for 60 minutes to remove any extra oil from the membranes; on the LIMs where the excess oil was allowed to runoff the sample, a tilt angle of 37±7° and a statistically lower tilt angle of 19±8° for K103- and K107-LIMs, respectively, was observed. Without wishing to be bound by theory, the K107-LIMs are believed to exhibit a lower tilt angle than the K103-LIMs because of the oil's higher viscosity and surface tension that might lead to a greater volume of oil being retained on the surface. Overall, these decreased tilt angles further confirm the presence of the slippery lubricant layer on the membranes, i.e., the presence of an oil layer that enables the sliding of a water droplet to occur at a lower tilt angle.

### Pure Water Permeance of LIMs as a Function of Transmembrane Pressure (TMP)

The ability of LIMs to be used in high pressure systems was investigated. The optimal transmembrane pressure (TMP) to carry out long term experiments was determined by performing pure water permeance experiments as a function of TMP (e.g., at 1, 2, 3, and 4 bar). The dotted line on FIG. 2 represents the permeance of the bare (non-infused) membrane, against which, the data was normalized. All permeance values for LIMs were statistically lower than the bare PVDF membranes, even at the highest TMP of 4 bar (the limit of our dead-end stirred cell). This indicates that lubricant is retained in/on the membranes after testing at all TMPs used in this work. It is desirable for the LIMs to have a lower flux than the bare membranes.

At the lowest TMP (1 bar), K103-LIMs and K107-LIMs both exhibited a very low permeance, close to zero. After increasing the TMP from 1 bar to 2 bar, a statistically significant increase in the normalized permeance (see Equation 3), was observed for the K103- and K107-LIMs. Without wishing to be bound by theory, this is likely because a threshold TMP was reached between 1 and 2 bar, resulting in potentially the opening of the pores if they were clogged with the oil or, simply an allowance of the water to pass through oil-decorated pores. Increasing the operating pressure to 2 bar also revealed that the viscosity of lubricant oil yielded a statistically different LIM permeance. To better understand this threshold, pure water permeance experiments at TMPs of 1.3 bar and 1.5 bar were also performed and revealed a statistical increase from 1 to 1.3, as well as from 1.3 to 1.5 bar. While we report the statistical rise in normalized permeance from 1 to 2 bar, additional increases were also observed at larger applied pressures. The normalized permeance of the K103-LIMs statistically increased to 0.55 and 0.62, whereas the normalized permeance of the K107-LIMs increased to 0.49 and 0.55 at TMPs of 3 and 4 bar, respectively. The K103-LIMs exhibited a 12% greater increase in the normalized permeance than the K107-LIMs at 4 bar. Without wishing to be bound by theory, this suggests that the higher viscosity lubricant fills more volume of the membrane's pores. Increasing the operating pressure revealed that the viscosity of lubricant oil statistically changed the membrane permeance. All these results demonstrate that LIMs can provide consistent flux and suggest the presence of a stable lubricant layer for a 30 min testing duration. Based on these results, the long-term experiments in the following sections use 1.5 bar TMP, which was considered to be the threshold pressure whereupon increased water permeance was observed. In other words, while an increase in pure water permeance was also observed at higher applied pressures, it is preferable to operate at the lowest threshold pressure to conserve energy.

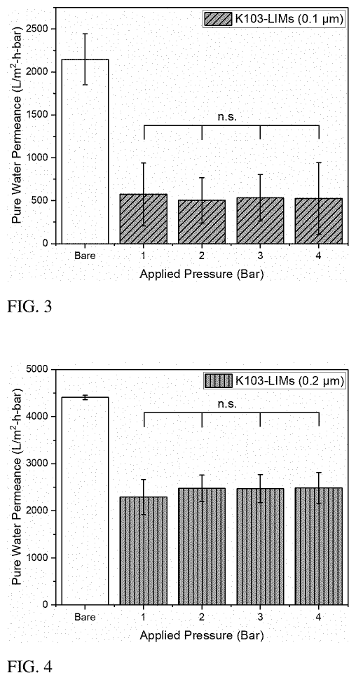

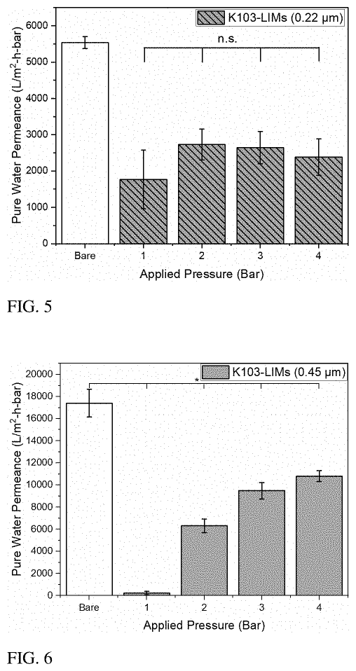

The effect of bare membrane pore size was also examined using four different bare membrane pore sizes (0.1, 0.2, 0.22, and 0.45 μm). The pure water permeance for all the K103-LIMs were lower than the water permeance of the bare membranes. This indicates the successful retention of lubricant in/on the membranes after testing at all TMPs and all four membrane pore sizes. LIMs prepared on a variety of base membranes had successful water permeance. FIG. 3 shows pure water permeance of K103-LIMs with a bare membrane pore size of 0.1 μm as a function of transmembrane pressure (TMP). FIG. 4 shows pure water permeance of K103-LIMs with a bare membrane pore size of 0.2 μm as a function of transmembrane pressure (TMP). FIG. 5 shows pure water permeance of K103-LIMs with a bare membrane pore size of 0.22 μm as a function of transmembrane pressure (TMP). FIG. 6 shows pure water permeance of K103-LIMs with a bare membrane pore size of 0.45 μm as a function of transmembrane pressure (TMP). Error bars denote standard deviation and one asterisk (*) denotes a p≤0.05 significance between samples. Error bars denote standard deviation and n.s. denotes a non-statistically significant difference between samples.

### Long-Term Pure Water Permeance of LIMs as a Function of Resting Time

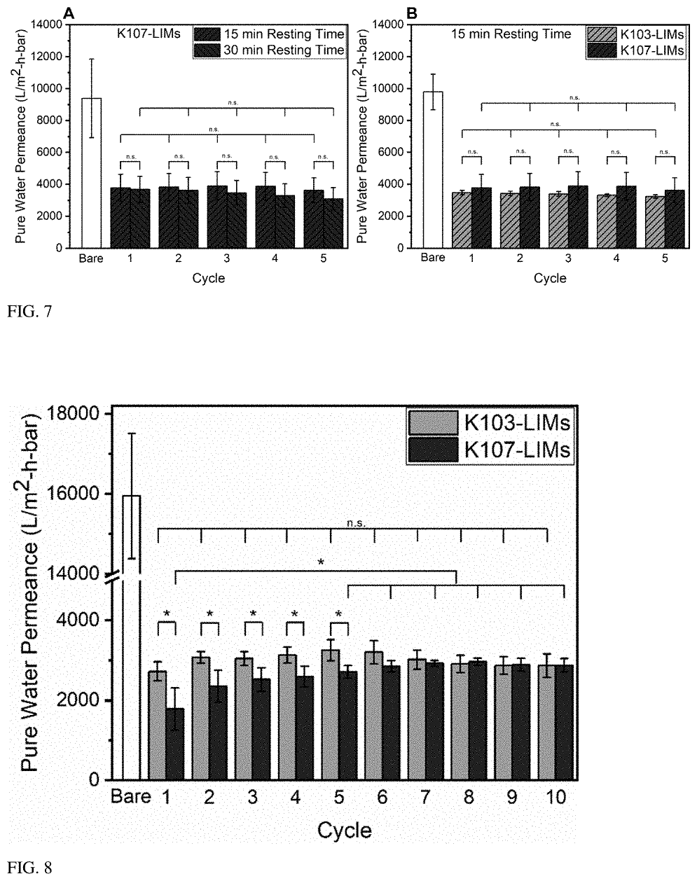

“Resting time” is defined as the time required for the system to refill with oil, which assists in passive flux recovery. To determine if incorporating a resting time would impact the flux behavior of LIMs disclosed herein, five permeance experiments were performed at a TMP of 1.5 bar and after each cycle, the LIMs were allowed to “rest” in the system (no applied pressure) for 15 or 30 minutes, as provided in FIG. 7A. Interestingly, K107-LIMs with 15 and 30 minute resting times exhibited a statistically equivalent permeance for each cycle and a lower permeance than the bare membranes.

Because no statistically relevant permeance differences with 15- and 30-minute resting time were noted, pure water permeance experiments were performed using K103-LIMs with the lower resting time (i.e., 15 minutes) and compared the values with that of K107-LIMs. Statistically equivalent permeances were again observed for K103- and K107-LIMs (FIG. 3B) confirming that resting time has no effect on the permeance at a TMP of 1.5 bar. The pure water permeances for K103-LIMs after 1 cycle and 5 cycle were 3476±135 and 3230±104 L m⁻² h⁻¹ bar⁻¹, respectively, and for K107-LIMs pure water permeances of 3777±836 and 3623±780 L m⁻² h⁻¹ bar⁻¹ were observed.

The results in FIG. 7B inform us that the permeance values at 1.5 bar TMP do not depend on the lubricant viscosity as equivalent pure water permeances were observed. Again, resting time had no effect on the permeance. While a threshold pressure was found to be required to open the pores or achieve an initial flux, with the higher pressure system disclosed herein, without wishing to be bound by theory, it is hypothesized that once the oil-coated pores allow for the passage of water, they did not refill and hence, no “gating” mechanism was observed. “Gating mechanism” refers to on applying pressure, the liquid is pressed against the pore walls allowing the filtration liquid to pass and when this pressure is released, the pores can be refilled by the liquid. Thus, a very stable system has been discovered at all applied pressures. In fact, without the presence of a gating mechanism, resting time has no effect on the permeance and thus, the present system can advantageously be operated continuously. The statistically equivalent permeance suggests that no oil is leaving the system; this is further analyzed and discussed in the following sections.

### Continuously Operated, Long-Term Pure Water Permeance of LIMs

With the knowledge that resting time does not impact permeance, 10 cycles of pure water permeance experiments were performed continuously, without any resting time, as shown in FIG. 8. For K103-LIMs, over 10 cycles, a consistent permeance of 3000 L m⁻² h⁻¹ bar⁻¹ was observed. This result suggests that very little to no oil is leaving the system and that the same amount of water is flowing per unit time, per unit area and per bar pressure. If oil was being removed from the membranes, then the flux would dramatically increase, likely to the permeance values demonstrated by the bare membrane (e.g., 16000 L m⁻² h⁻¹ bar⁻¹). In all cases, the permeance for both K103- and K107-LIMs was lower than the permeance of bare PVDF membranes confirming the presence of the oil in the membrane pores. In the case of K107-LIMs, an increase in the permeance value was observed until cycle 5 and consistent permeance values from cycle 5 onwards. Additionally, the pure water permeance value for cycle 1 was statistically different from the pure water permeances for cycle 5 to cycle 10. Without wishing to be bound by theory, it is believed that this behavior may result from the higher viscosity lubricant taking more time to form a steady membrane pore coating when operating the system at 1.5 bar TMP. Once a steady membrane pore coating was formed, a stable flux of 2900 L m⁻² h⁻¹ bar⁻¹ was observed for cycles 5-10.

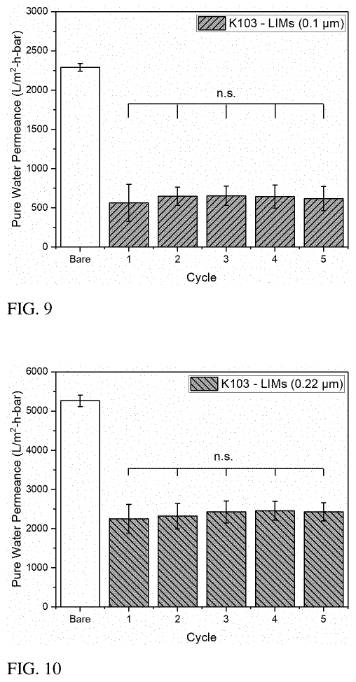

In another test, five cycles of pure water permeance experiments were performed continuously using 0.1 and 0.22 μm pore size membranes at 1.5 bar TMP (FIG. 9 and FIG. 10). The permeance for K103-LIMs (0.1 μm) and K103-LIMs (0.22 μm) are significantly lower than their respective bare membrane permeances confirming the presence of oil inside the membrane pores. This means that the oil coating is stable on the 0.1 and 0.22 μm membrane pore sizes. For K103-LIMs (0.1 μm) and K103-LIMs (0.22 μm), a consistent permeance of ˜700 L m⁻² h⁻¹ bar⁻¹ and ˜2500 L m⁻² h⁻¹ bar⁻¹ was observed, respectively. This suggests that very little to no oil is leaving the system. If oil was being removed from the membranes, then the flux would dramatically increase and reach the permeance values demonstrated by their corresponding bare membranes.

### Lubricant Stability in the LIMs Using Thermogravimetric Analysis Post-Pure Water Permeance Testing

Thermogravimetric analysis (TGA) was used to quantify the amount of PFPE (e.g., K103 and K107) present in the as-prepared membranes and the LIMs used in pure water permeance tests. The TGA data is shown in Table 2.

TABLE 2

| | | | PFPE/ |
|---|---|---|---|
| | | Bare | Membrane |
| | | Membrane | (K/M) |
| Membrane | PFPE (%) | (%) | Ratio^{†} |
| K103-LIM (As-Prepared) | 44 ± 5 | 38 ± 6 | 1.197 ± 0.39 |
| K103-LIM (After Cycle 1) | 23 ± 7 | 53 ± 7 | 0.445 ± 0.16 |
| K103-LIM (After Cycle 2) | 19 ± 6 | 57 ± 6 | 0.338 ± 0.11 |
| K103-LIM (After Cycle 3) | 19 ± 9 | 60 ± 8 | 0.338 ± 0.18 |
| K103-LIM (After Cycle 4) | 22 ± 6 | 57 ± 7 | 0.399 ± 0.14 |
| K103-LIM (After Cycle 5) | 22 ± 7 | 54 ± 5 | 0.404 ± 0.13 |
| K107-LIM (As-Prepared) | 41 ± 6 | 51 ± 6 | 0.839 ± 0.22 |
| K107-LIM (After Cycle 1) | 40 ± 3 | 51 ± 4 | 0.805 ± 0.07 |
| K107-LIM (After Cycle 2) | 36 ± 6 | 49 ± 7 | 0.744 ± 0.09 |
| K107-LIM (After Cycle 3) | 34 ± 3 | 46 ± 5 | 0.738 ± 0.05 |
| K107-LIM (After Cycle 4) | 36 ± 4 | 49 ± 5 | 0.750 ± 0.07 |
| K107-LIM (After Cycle 5) | 36 ± 6 | 49 ± 5 | 0.728 ± 0.09 |

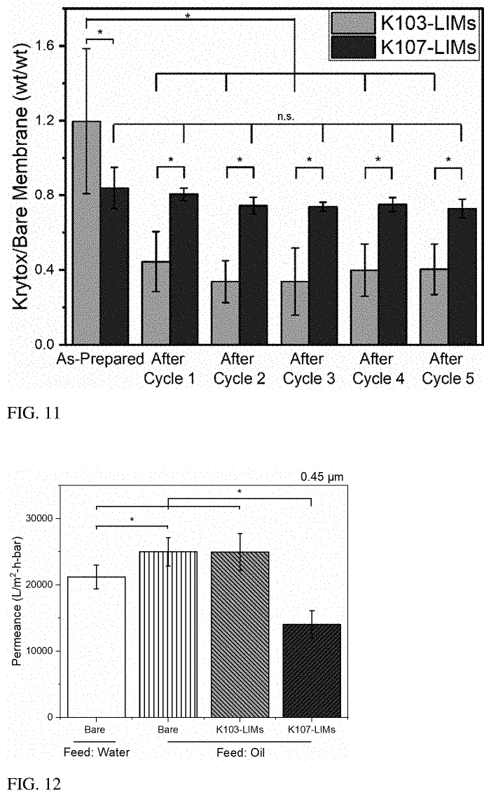

Equation 4 was used to calculate the proportion of PFPE to the bare membrane. The weight percentage of PFPE for the as-prepared K103- and K107-LIMs was 44±5% and 41±6%, respectively. The K/M ratio for the K103-LIMs was greater than 1, whereas for K107-LIMs it was less than 1, which suggests that the weight of K103 was more than the weight of bare membrane, whereas in the case of K107, it was less than the weight of bare membrane. For K103-LIMs, the K/M ratio dropped from 1.19±0.39 for the as-prepared membranes to 0.45±0.16 for membranes used in one permeance test, i.e., 0.8 mg cm⁻² of K103 was removed, as shown in FIG. 11. Importantly, there was no significant difference, i.e., no weight change from cycle 1 to cycle 5 for the K103-LIMs. The pure water permeance data (FIG. 8) and TGA data (FIG. 11) support the fact that K103 reached a steady state concentration after one cycle of use and retained a consistent permeance over the next 9 cycles. This would only be possible if the oil remained on the membrane as a stable layer. Since all detectable K103 losses occurred after cycle 1, a pretreatment procedure like forward flushing, pulling pressure during membrane fabrication, or washing the membrane surface could be performed to overcome this limitation. Additionally, further optimizations to the initial quantity of oil being applied to the membrane and/or the duration of the step where we hold the membrane vertically to allow the excess oil to runoff during the fabrication step can be optimized to minimize excess lubricant. Alternatively, if the PFPE oil was initially applied to the membranes using industrial coating processes (i.e., not via hand pipetting) it should be possible to initially achieve a thinner layer of oil.

For the K107-LIMs, the K/M ratio of the as-prepared membranes was statistically equivalent to the K/M ratio of the used membranes from cycles 1 to 5 of permeance tests. Without wishing to be bound by theory, these phenomena are believed to have been observed due to the higher viscosity of K107. In the case of K107-LIMs, potentially less oil can enter the membrane's pores due to its higher viscosity and more oil drips off during the membrane preparation step. However, the oil that goes into the pores is very stable at 1.5 bar TMP and thus, the normalized values are equivalent. A stable liquid-infusion is fabricated even before applying pressure and thus, no change in the K/M ratio for the K107-LIMs is observed.

### Pure Oil Permeance of LIMs

The bare membranes and LIMs were challenged with an example hydrophobic liquid, silicone oil, to see if hydrophobic liquids could pass through the membrane. FIG. 12 demonstrated that indeed the LIMs are stable and can be used for hydrophobic liquid separations, including oily separations. The K103-LIMs showed a statistically equivalent pure oil permeance to that of the bare membrane. The K107-LIMs showed a statistically lower pure oil permeance compared to that of the bare membrane.

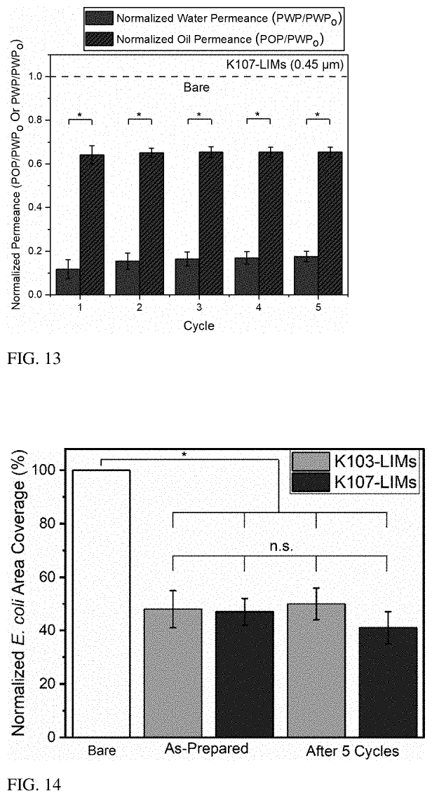

Five cycles of pure oil permeance experiments were performed using the K107-LIMs and the normalized oil permeance was compared with the normalized water permeance, as shown in FIG. 13. The normalized oil permeance for K107-LIMs is statistically equivalent over all 5 cycles. This experiment indicates that the K107-LIMs are stable and can be used for multiple cycles of separating hydrophobic liquids, including oils and oily wastewaters.

### Bacterial Antifouling Activity of LIMs

The resistance to bacterial fouling was determined for the LIMs and compared to the bare membranes using E. coli. Statistically, fewer E. coli attached to the K103- and K107-LIMs than to the bare membranes, as shown in FIG. 14. In comparison to the bare membranes, E. coli attachment decreased by 50%, to 48±7% and to 47±5% for K103-LIMs and K107-LIMs, respectively. Glass coverslips were run as an internal control (data not shown) and fouled significantly more than any of the membranes. Looking to the literature, SLIPS fabricated by immobilizing PFPE (K100 and K103) liquids on PTFE supports showed a reduction in biofilm coverage of E. coli by 96% and S. aureus by 97.2%. All previous work on liquid infused surfaces featured the gating mechanism, which implies that the oil is moving; during this oil movement it has been postulated that the bacteria are being pulled off along with the non-stable liquid coating. Due to the uniquely stable oil-coated membranes of the present disclosure, a direct comparison between the present data on initial adhesion and published data on biofilm formation is challenging.

E. coli attachment to the LIMs was also assayed after performing 5 cycles of pure water permeance experiments. E. coli attachment again decreased significantly compared to the bare membranes to 50±6% and 41±6% for the used K103-LIMs and K107-LIMs, respectively, in comparison to the bare membranes. In fact, a statistically equivalent antifouling performance was demonstrated by both the as-prepared LIMs and the LIMs after 5 cycles of use. These results demonstrate that LIMs are highly repellant to the microorganism E. coli, even after using them for pure water permeance experiments. The improvement in bacterial antifouling capabilities, especially for the used K103- and K107-LIMs, reinforces that a continuous, stable lubricant coating was formed and maintained. In a particularly remarkable feature, no change in the bacterial adhesion after 5 cycles of using the LIMs was observed even though a small amount of lubricant oil is removed during the pure water permeance experiments (as suggested by the TGA data).

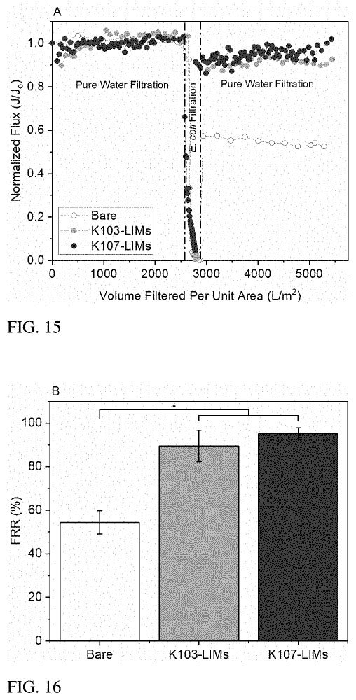

A dynamic bacterial antifouling test was conducted on the bare and LIMs using pure water and bacteria suspensions in a dead-end stirred cell. Initial flux of the bare was statistically different from that of the LIMs. The initial flux of bare, K103-LIMs, and K107-LIMs decreased sharply suggesting the instantaneous deposit of bacteria on the membrane surface (FIG. 15). After rinsing the membranes with DI water for 10 min, it can be observed that, the LIMs demonstrated a larger flux recovery compared to the bare membranes. This indicates that the LIMs have a better resistance to fouling my microorganism than the bare membranes. FIG. 16 shows that LIMs had a statistical increase in their FRR compared to that of the bare membranes indicating better dynamic fouling resistance of a membrane. On challenging the membranes with a high concentration of E. coli (10⁷ CFU mL⁻¹), the FRR increased from 54±5 for bare membranes to 90±7 and 95±3 for K103-LIMs and K107-LIMs, respectively. The LIMs are highly antifouling even when tested using dynamic conditions.

Thus, these results strongly support that ample PFPE remains on the surface of the membranes after their long-term use for both continued membrane function and antifouling properties. Accordingly, the present disclosure has provided fabrication of LIMs that have a continuous immobilized lubricant coating, great membrane flux, and effective antifouling properties.

This disclosure further encompasses the following aspects.

Aspect 1: A liquid infused membrane comprising a porous fluorine-containing polymer membrane having a first surface and a second surface and comprising a plurality of pores, each pore defined by a pore wall comprising the fluorine-containing polymer; and a perfluoropolyether oil coating on at least a portion of the first surface and at least a portion of the pore wall, wherein a fluid can pass through the membrane when a transmembrane pressure is applied, and wherein the liquid infused membrane does not exhibit gating upon removal of the transmembrane pressure.

Aspect 2: The liquid infused membrane of aspect 1, exhibiting an initial threshold pressure above which at least a portion of the perfluoropolyether oil coating is displaced to allow a fluid to pass through the membrane.

Aspect 3: The liquid infused membrane of aspect 1, wherein the liquid infused membrane does not exhibit a threshold pressure to allow a fluid to pass through the membrane.

Aspect 4: The liquid infused membrane of any of aspects 1 to 3, wherein the liquid infused membrane exhibits pure water permeance at a transmembrane pressure of greater than or equal to 1 bar, preferably 1 to 5 bar, or 1.5 to 5 bar, or 1.5 to 4 bar, pure oil permeance at a transmembrane pressure of less than or equal to 5 bar, or less than or equal to 2 bar, or 0.1 to 5 bar, or 0.1 to 2 bar, or 0.1 to 0.75 bar, or 0.25 to 0.75 bar, or 1 to 2 bar, or 1.25 to 1.75 bar.

Aspect 5: The liquid infused membrane of aspect 4, wherein the pure water permeance is less than the pure water permeance of the porous fluorine-containing polymer membrane not including the perfluoropolyether oil, or wherein the pure oil permeance is less than the pure oil permeance of the porous fluorine-containing polymer membrane not including the perfluoropolyether oil.

Aspect 6: The liquid infused membrane of any of aspects 1 to 5, wherein the fluorine-containing polymer membrane comprises polyvinylidene fluoride.

Aspect 7: The liquid infused membrane of any of aspects 1 to 6, wherein the perfluoropolyether oil has the structure F—(CF(CF₃)CF₂O)n-CF₂CF₃, wherein n is 10 to 60.

Aspect 8: The liquid infused membrane of any of aspects 1 to 7, wherein the perfluoropolyether oil has a viscosity of 75 to 90 cSt (0.000075 to 0.00009 m² s⁻¹) at a temperature of 20° C., preferably 75 to 85 cSt (0.000075 to 0.000085 m² s⁻¹).

Aspect 9: The liquid infused membrane of any of aspects 1 to 7, wherein the perfluoropolyether oil has a viscosity of 1500 to 1550 cSt (0.0015 to 0.00155 m² s⁻¹) at a temperature of 20° C., preferably 1525 to 1545 cSt (0.001525 to 0.001545 m² s⁻¹).

Aspect 10: The liquid infused membrane of any of aspects 1 to 9, wherein the perfluoropolyether oil is present in a perfluoropolyether oil:membrane weight ratio of 0.2:1 to 1.5:1, or 0.3:1 to 0.5:1, or 0.75:1 to 0.9:1.

Aspect 11: The liquid infused membrane of any of aspects 1 to 10, comprising a porous polyvinylidene fluoride membrane; and a perfluoropolyether oil having the structure F—(CF(CF₃)CF₂O)n-CF₂CF₃, wherein n is 10 to 60 on the porous polyvinylidene fluoride membrane.

Aspect 12: The liquid infused membrane of aspect 11, wherein the perfluoropolyether oil has a viscosity of 75 to 90 cSt (0.000075 to 0.00009 m² s⁻¹) at a temperature of 20° C.; and wherein the perfluoropolyether oil is present in a perfluoropolyether oil:membrane weight ratio of 0.3:1 to 0.5:1.

Aspect 13: The liquid infused membrane of aspect 11, wherein the perfluoropolyether oil has a viscosity of 1500 to 1550 cSt (0.0015 to 0.00155 m² s⁻¹) at a temperature of 20° C.; and wherein the perfluoropolyether oil is present in a perfluoropolyether oil:membrane weight ratio of 0.75:1 to 0.9:1.

Aspect 14: The liquid infused membrane of any of aspects 1 to 13, wherein the liquid infused membrane reduces adhesion of bacteria by at least 45%, preferably by at least 50% relative to a porous fluorine-containing polymer membrane not including the perfluoropolyether oil.

Aspect 15: The liquid infused membrane of any of aspects 1 to 14, wherein the porous fluorine-containing polymer membrane has an average pore diameter of 0.1 to 20 μm, or 0.1 to less than 1 μm.

Aspect 16: A method of the manufacture of the liquid infused membrane of any of aspects 1 to 15, the method comprising: contacting the perfluoropolyether oil with the porous fluorine-containing polymer membrane; and removing excess perfluoropolyether oil to provide the liquid infused membrane.

Aspect 17: A method of water purification comprising passing water through the liquid infused membrane of any of aspects 1 to 15, the method comprising contacting the water with the liquid infused membrane at a transmembrane pressure effective to transport the water through the liquid infused membrane, wherein the liquid infused membrane does not exhibit gating upon removal of the pressure.

Aspect 18: The method of aspect 17, wherein passing water through the liquid infused membrane is at a transmembrane pressure of greater than or equal to 1 bar, preferably 1 to 5 bar, or 1 to 4 bar.

Aspect 19: A water purification system comprising the liquid infused membrane of any of aspects 1 to 15.

Aspect 20: A method of oil purification comprising passing oil through the liquid infused membrane of any of aspects 1 to 15, the method comprising contacting the oil with the liquid infused membrane at a transmembrane pressure effective to transport the oil through the liquid infused membrane, wherein the liquid infused membrane does not exhibit gating upon removal of the pressure.

Aspect 21: The method of aspect 20, wherein passing oil through the liquid infused membrane is at a transmembrane pressure of greater than or equal to 1 bar, preferably 1 to 5 bar, or 1 to 4 bar.

Aspect 22: An oil purification system comprising the liquid infused membrane of any of aspects 1 to 15.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “an aspect” means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue.

While particular aspects have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A liquid infused membrane comprising
a porous fluorine-containing polymer membrane having a first surface and a second surface and comprising a plurality of pores, each pore defined by a pore wall comprising the fluorine-containing polymer; and
a perfluoropolyether oil coating on at least a portion of the first surface and at least a portion of the pore wall;
wherein a fluid can pass through the membrane when a transmembrane pressure is applied, and
wherein the liquid infused membrane does not exhibit gating upon removal of the transmembrane pressure.

2. The liquid infused membrane of claim 1, exhibiting an initial threshold pressure above which at least a portion of the perfluoropolyether oil coating is displaced to allow the fluid to pass through the membrane.

3. The liquid infused membrane of claim 1, wherein the liquid infused membrane does not exhibit a threshold pressure to allow the fluid to pass through the membrane.

4. The liquid infused membrane of claim 1, wherein the liquid infused membrane exhibits pure water permeance at a transmembrane pressure of greater than or equal to 1 bar, pure oil permeance at a transmembrane pressure of less than or equal to 5 bar, or both.

5. The liquid infused membrane of claim 4, wherein the pure water permeance is less than the pure water permeance of the porous fluorine-containing polymer membrane not including the perfluoropolyether oil, wherein the pure oil permeance is less than the pure oil permeance of the porous fluorine-containing polymer membrane not including the perfluoropolyether oil, or both.

6. The liquid infused membrane of claim 1, wherein the fluorine-containing polymer membrane comprises polyvinylidene fluoride.

7. The liquid infused membrane of claim 1, wherein the perfluoropolyether oil has the structure F—(CF(CF₃)CF₂O)n-CF₂CF₃, wherein n is 10 to 60.

8. The liquid infused membrane of claim 1, wherein the perfluoropolyether oil has a viscosity of 75 to 90 cSt (0.000075 to 0.00009 m² s⁻¹) at a temperature of 20° C.

9. The liquid infused membrane of claim 1, wherein the perfluoropolyether oil has a viscosity of 1500 to 1550 cSt (0.0015 to 0.00155 m² s⁻¹) at a temperature of 20° C.

10. The liquid infused membrane of claim 1, wherein the perfluoropolyether oil is present in a perfluoropolyether oil:membrane weight ratio of 0.2:1 to 1.5:1.

11. The liquid infused membrane of claim 1, comprising
a porous polyvinylidene fluoride membrane; and
a perfluoropolyether oil having the structure F—(CF(CF₃)CF₂O)n-CF₂CF₃, wherein n is 10 to 60 on the porous polyvinylidene fluoride membrane.

12. The liquid infused membrane of claim 11,
wherein the perfluoropolyether oil has a viscosity of 75 to 90 cSt (0.000075 to 0.00009 m² s⁻¹) at a temperature of 20° C.; and
wherein the perfluoropolyether oil is present in a perfluoropolyether oil:membrane weight ratio of 0.3:1 to 0.5:1.

13. The liquid infused membrane of claim 11,
wherein the perfluoropolyether oil has a viscosity of 1500 to 1550 cSt (0.0015 to 0.00155 m² s⁻¹) at a temperature of 20° C.; and
wherein the perfluoropolyether oil is present in a perfluoropolyether oil:membrane weight ratio of 0.75:1 to 0.9:1.

14. The liquid infused membrane of claim 1, wherein the liquid infused membrane reduces adhesion of bacteria by at least 45%, preferably by at least 50% relative to a porous fluorine-containing polymer membrane not including the perfluoropolyether oil.

15. The liquid infused membrane of claim 1, wherein the porous fluorine-containing polymer membrane has an average pore diameter of 0.1 to 20 μm.

16. A method of the manufacture of the liquid infused membrane of claim 1, the method comprising:
contacting the perfluoropolyether oil with the porous fluorine-containing polymer membrane; and
leaving or removing excess perfluoropolyether oil to provide the liquid infused membrane.

17. A method of water purification comprising passing water through the liquid infused membrane of claim 1, the method comprising contacting the water with the liquid infused membrane at a transmembrane pressure effective to transport the water through the liquid infused membrane, wherein the liquid infused membrane does not exhibit gating upon removal of the pressure.

18. A method of oil purification comprising passing oil through the liquid infused membrane of claim 1, the method comprising contacting the oil with the liquid infused membrane at a transmembrane pressure effective to transport the oil through the liquid infused membrane, wherein the liquid infused membrane does not exhibit gating upon removal of the pressure.

19. A water purification system or an oil purification system comprising the liquid infused membrane of claim 1.
